(19) United States
(12) Patent Application Publication
(10) Pub. No.: US 2025/0131698 A1
(43) Pub. Date: Apr. 24, 2025

(54) FACIAL IMAGE PROCESSING METHOD AND APPARATUS, AND COMPUTER-READABLE STORAGE MEDIUM AND TERMINAL

(71) Applicant: SPREADTRUM COMMUNICATIONS (SHANGHAI) CO., LTD., Shanghai (CN)

(72) Inventor: Fuming XIE, Shanghai (CN)

(21) Appl. No.: 18/574,804

(22) PCT Filed: Dec. 27, 2021
(86) PCT No.: PCT/CN2021/141466

§ 371 Date: Dec. 28, 2023

(30) Foreign Application Priority Data
Jun. 28, 2021 (CN) 202110720571.2

(51) Int. Cl. G06V 10/80; G06V 10/141; G06V 10/34; G06V 10/56; G06V 10/60; G06V 40/16

(52) U.S. Cl. CPC G06V 10/80; G06V 10/141; G06V 10/34; G06V 10/56; G06V 10/60; G06V 40/171

(57) ABSTRACT

A facial image processing method and apparatus, a computer-readable storage medium and a terminal are provided. The facial image processing method includes: acquiring a lip mask in a to-be-processed facial image, wherein the lip mask is a mask of a lip area; acquiring an initial image of lipstick trial makeup based on luminance of the to-be-processed facial image subjected to luminance and color separation, and a color of a target lipstick sample subjected to luminance and color separation; and performing image fusion on the initial image of lipstick trial makeup and the to-be-processed facial image based on the lip mask to acquire a lipstick trial makeup image.

### CROSS-REFERENCE TO RELATED APPLICATIONS

This is the U.S. national stage of application No. PCT/CN2021/141466, filed on Dec. 27, 2021. Priority under 35 U.S.C. § 119(a) and 35 U.S.C. § 365(b) is claimed from Chinese Application No. 202110720571.2, filed Jun. 28, 2021, the disclosure of which is also incorporated herein by reference.

### BACKGROUND

With development of Internet and mobile communication technology, virtual face makeup is leading transformation of the beauty industry. Through virtual face makeup, users can try out lipsticks of various colors without actually applying lipstick.

### SUMMARY

Embodiments of the present disclosure may reduce a difference between a lipstick trial makeup effect during virtual face makeup and a real lipstick coloring effect, and improve the lipstick coloring effect and naturalness in lipstick trial makeup images.

In an embodiment of the present disclosure, a facial image processing method is provided, including: acquiring a lip mask in a to-be-processed facial image, wherein the lip mask is a mask of a lip area; acquiring an initial image of lipstick trial makeup based on luminance of the to-be-processed facial image subjected to luminance and color separation, and a color of a target lipstick sample subjected to luminance and color separation; and performing image fusion on the initial image of lipstick trial makeup and the to-be-processed facial image based on the lip mask to acquire a lipstick trial makeup image.

In an embodiment of the present disclosure, a non-volatile or non-transitory computer readable storage medium having computer instructions stored therein is provided, wherein when the computer instructions are executed by a processor, any one of the above facial image processing methods is performed.

In an embodiment of the present disclosure, a terminal including a memory and a processor is provided, wherein the memory has computer instructions stored therein, and when the processor executes the computer instructions, any one of the above facial image processing methods is performed.

### BRIEF DESCRIPTION OF THE DRAWINGS

FIG. 1 is a flow chart of a facial image processing method according to an embodiment;

FIG. 2 is a position diagram of key points on a face according to an embodiment;

FIG. 3 is a flow chart of a facial image processing method according to an embodiment; and

FIG. 4 is a block diagram of a facial image processing apparatus according to an embodiment.

### DETAILED DESCRIPTION

As described in the background, a lipstick trial makeup effect presented by current virtual face makeup has a strong texture, which is quite different from a real coloring effect of a user's lipstick, and naturalness is relatively low.

In the embodiments of the present disclosure, the initial image of lipstick trial makeup is acquired based on the luminance of the to-be-processed facial image subjected to luminance and color separation, and the color of the target lipstick sample subjected to luminance and color separation. Image fusion is performed on the initial image of lipstick trial makeup and the to-be-processed facial image based on the lip mask to acquire the lipstick trial makeup image. As the initial image of lipstick trial makeup is acquired based on the luminance of the to-be-processed facial image subjected to luminance and color separation, the initial image of the lipstick trial makeup cannot only present a color of the lipstick, but also contain texture information of the lip area. Therefore, the lipstick trial makeup image acquired based on the fusion of the initial image of lipstick trial makeup and the to-be-processed facial image can better retain the texture information of the lip area, and takes into account real lip colors of different groups of people, so as to better simulate a real effect of lipstick color applied to lips, thereby reducing a difference between lipstick coloring effect in the lipstick trial makeup image and an actual lipstick coloring effect in reality, and improving the lipstick coloring effect and naturalness in the lipstick trial makeup image.

In order to clarify the objects, characteristics and advantages of the disclosure, embodiments of present disclosure will be described in detail in conjunction with accompanying drawings.

Embodiments of the present disclosure provide a facial image processing method. The facial image processing method may be used for virtual facial makeup in a variety of scenarios, such as lipstick trial makeup application scenarios, image beauty application scenarios, or video beauty application scenarios. The to-be-processed facial image in the embodiments of the present disclosure may be an image acquired by an image acquisition device such as a camera or may be one or more image frames in a video. An execution subject of the facial image processing method may be a chip in a terminal, or may be a chip, such as a control chip or a processing chip, or various other appropriate components that can be used in the terminal.

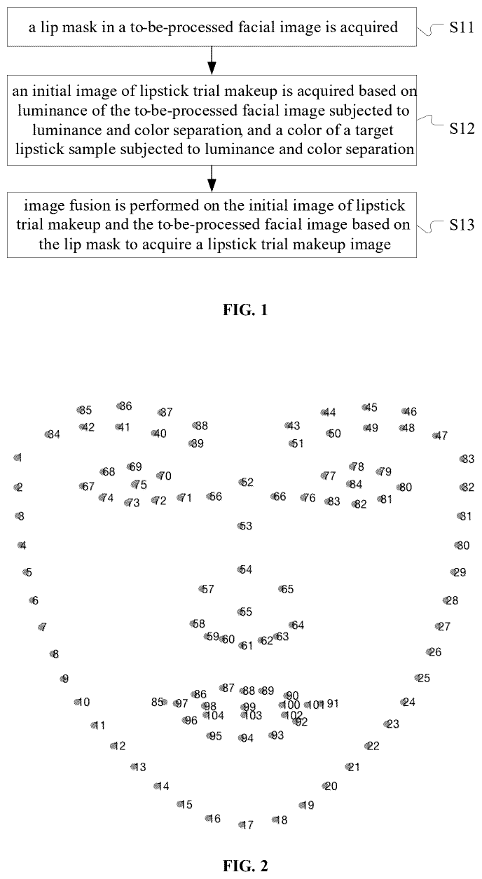

Referring to FIG. 1, FIG. 1 is a flow chart of a facial image processing method according to an embodiment, which may specifically include S11, S12 and S13.

In S11, a lip mask in a to-be-processed facial image is acquired.

In some embodiments, the lip mask is a mask of a lip area.

In some embodiments, the lip mask in the to-be-processed facial image may be acquired in a following manner.

Said acquiring the lip mask in the to-be-processed facial image includes: performing face key point alignment on the to-be-processed facial image, and determining the lip area based on lip key points among the face key points; retaining the lip area, triangulating areas in the to-be-processed facial image except the lip area, and acquiring a binary image by converting; performing edge smoothing on the binary image by using luminance channel information of the to-be-processed facial image as a guide map; and determining the lip mask based on the binary image subjected to the edge smoothing. By smoothing an edge of the lip area, an edge jump of the lip area is avoided, so that the lip edge in the lip mask is consistent with a lip line on a face in the to-be-processed facial image, which helps to further improve the effect of the lipstick trial makeup image acquired by subsequent image fusion.

The luminance channel information of the to-be-processed facial image may be Y channel information in a YUV color space. “Y” represents luminance or luma, i.e., a gray scale value, while “U” and “V” represent chrominance or chroma which is used to describe a color and saturation of images and specify the color of pixels. The luminance channel information of the to-be-processed facial image may be V channel information in a HSV color space, where H is hue, S is saturation, H is value. HSV is also called HSB (‘B’ is brightness). The luminance channel information of the to-be-processed facial image may be L channel information in a Lab color space, where L is luminance, colors included in ‘a’ are from dark green (low luminance value) to gray (medium luminance value) to bright pink (high luminance value), and colors included in ‘b’ are from bright blue (low luminance value) to gray (medium luminance value) to yellow (high luminance value). The luminance channel information of the to-be-processed facial image may be luminance information in other color spaces, which is not described in detail here.

In some embodiments, various methods may be used to implement edge smoothing on the binary image to achieve a smooth transition between a boundary of the lip area and surrounding areas. For example, fast guided filtering may be used to smooth the edge of the binary image. As another example, other types of edge feathering are used to smooth the edge of the binary image. It could be understood that other methods may be possibly used to perform edge smoothing on the binary image.

In some embodiments, a filter radius used for edge smoothing of the binary image may be determined based on empirical values or based on a size of lips.

In practice, taking into account individual needs of different users, the filter radius may be determined based on a type of lip makeup. By determining the filter radius based on the type of lip makeup, the fusion weight of pixels near the edge of the lip area in the lip mask is adjusted, thereby realizing a gradient effect after fusion of the pixels near the edge of the lip area, to achieve different types of lip makeup needs such as bitten lip makeup, full lip makeup or smiling lips, which meets the personalized needs of different users.

Further, to improve accuracy of the lip mask, accuracy of face alignment may be improved. Accuracy of positions of face key points may be improved based on face recognition technology and high-precision face alignment technology. By improving the accuracy of the positions of the face key points, the accuracy of the lip mask is improved.

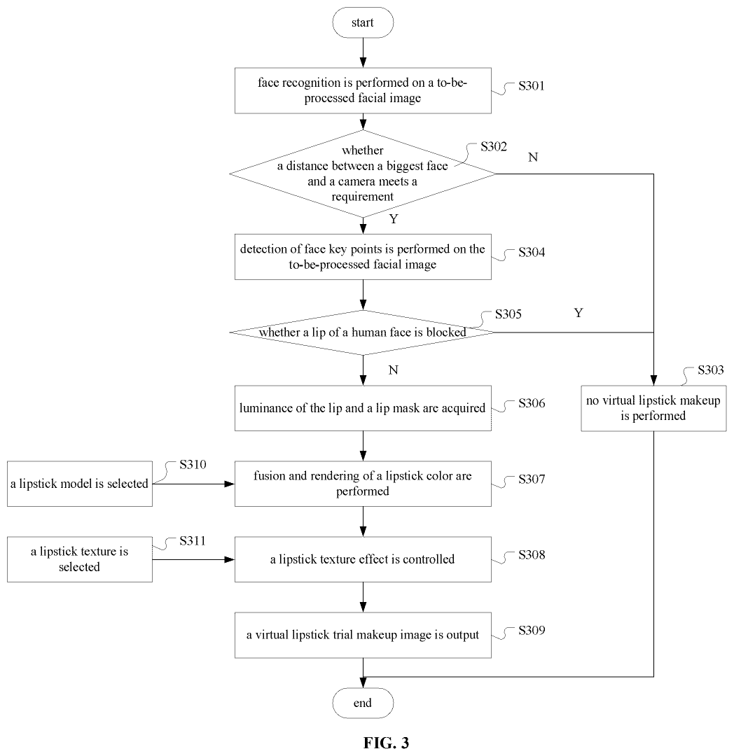

Referring to FIG. 2, FIG. 2 is a position diagram of key points on a face according to an embodiment. A number of face key points shown in FIG. 2 is 104 (that is, gray points numbered 1 to 104 in the figure). In practice, depending on required feature information for the face area, other face key points may be added in other areas, such as adding face key points in a forehead area or a hairline area, so that the number of the face key points is not limited to this, and may be other numbers, which is not described in detail here.

In some embodiments, lip key points may be used to constrain an outline of a lip. As shown in FIG. 2, the lip key points may include numbers 85 to 104 in the figure. It should be noted that FIG. 2 is only a schematic illustration. In practice, the number and positions of the face key points and the lip key points may be configured according to needs.

Further, prior to S11, the acquired to-be-processed facial image may be checked to determine whether the to-be-processed facial image meets a certain requirement. For example, face recognition is performed after the to-be-processed facial image is scaled, and a distance between the enlarged biggest face and a terminal device is calculated. If a set distance is met, it is determined that the requirement is met; or if the set distance is not met, it is determined that the requirement is not met. If the face area in the to-be-processed facial image accounts for a small proportion of the overall facial image, even if the to-be-processed facial image is subjected to lip makeup processing, the lip makeup effect may be nonobvious due to the small lip area. By scaling the to-be-processed facial image, if the distance between the enlarged biggest face and the terminal device does not meet the set distance, the proportion of the face area in the to-be-processed facial image is relatively small, and the lip makeup may not be performed. That is, no subsequent steps are performed.

Further, prior to S11, a face pose of the to-be-processed facial image may be detected. If a face pose angle of the to-be-processed facial image exceeds a set angle, it is determined that the face pose angle is too large and no further processing is performed. For example, in a scenario where the lip area is not detected, or even that the face pose is detected to be a back, and a face cannot be recognized, it is unnecessary to perform lip makeup processing, that is, no subsequent steps are performed.

By checking the to-be-processed facial image before S11, and selectively performing image processing on the to-be-processed facial image, subsequent steps of S12 and S13 may be performed on the to-be-processed facial image that meets the requirement, and not performed on the to-be-processed facial image that does not meet the requirement. In this manner, an image processing effect is improved, and computing resources are saved.

In some embodiments, the to-be-processed facial image may include one face or multiple faces. When the to-be-processed facial image includes multiple faces, the lip mask may be determined separately for the lip area of each face.

In S12, an initial image of lipstick trial makeup is acquired based on luminance of the to-be-processed facial image subjected to luminance and color separation, and a color of a target lipstick sample subjected to luminance and color separation.

In some embodiments, the luminance and color separation may be performed on the to-be-processed facial image and the color of the target lipstick sample in multiple types of color spaces. To ensure the effect of the acquired initial image of lipstick trial makeup, the luminance and color separation is performed on the to-be-processed facial image and the color of the target lipstick sample in the same color space.

For example, the initial image of lipstick trial makeup is acquired based on the luminance Y of the to-be-processed facial image subjected to luminance and color separation, and the color UV of the target lipstick sample subjected to luminance and color separation in a YUV color space.

For another example, the initial image of lipstick trial makeup is acquired based on the luminance V of the to-be-processed facial image subjected to luminance and color separation, and the color HS of the target lipstick sample subjected to luminance and color separation in an HSV color space.

It could be understood that other situations may also be possible, which is not described in detail here.

In some embodiments, corresponding color attribute information may be configured for each lipstick sample to characterize chrominance and luminance of the color. Depending on the selected color space, the color attribute information is represented in different ways. For example, the color attribute information is represented by [R, G, B, Y] based on an RGB color space, where R represents red, G represents green, B represents blue, and Y represents default luminance of the lipstick. For using this method to configure the color attribute information of the lipstick sample, it only needs to configure and acquire [R, G, B, Y] of the lipstick sample to achieve a trial makeup effect of any lipstick, and it is also convenient to enrich colors and types of lipstick samples. The default luminance Y of the lipstick may be acquired based on conversion of the R, G and B information of the lipstick. Specifically, the default luminance Y can be acquired by converting the color of the lipstick sample from the RGB color space to the YUV color space. It could be understood that the color attribute information of the lipstick sample may also be represented by other color spaces, for example, by the YUV color space or the HSV space.

In some embodiments, when the color space type of the to-be-processed facial image is different from the color space type of the target lipstick sample, the color space type of the to-be-processed facial image and the color space type of the target lipstick sample are converted to a same color space type.

In some embodiments, when the to-be-processed facial image adopts the YUV color space, and the color of the target lipstick-sample adopts the RGB color space, the color spaces of the to-be-processed facial image and the color of the target lipstick sample may be converted to the HSV color space. The initial image of lipstick trial makeup image is acquired based on the luminance V of the to-be-processed facial image in the HSV color space and the color (hue H and saturation S) of the color of the target lipstick sample in the HSV color space.

Specifically, the corresponding color of the target lipstick sample in the HSV color space may be calculated based on [R, G, B] of the target lipstick sample using a following formula (1):

$$[ h , s , v ] = RGB 2 HSV ( R , G , B ) , \qquad ( 1 )$$

where RGB 2 HSV ( ) represents the conversion from the RGB color space to the HSV color space, h is the hue of the target lipstick sample, s is the saturation of the target lipstick sample, and v is the value of the target lipstick sample.

An initial color space of the to-be-processed facial image is the YUV color space, and the to-be-processed facial image is converted from the YUV color space to the RGB color space using, for example, a following formula (2):

$$[ srcR , srcG , srcB ] = YUV 2 RGB ( srcY , srcU , srcV ) , \qquad ( 2 )$$

where YUV 2 RGB ( ) represents the conversion from the YUV color space to the RGB color space, srcY is the luminance of the to-be-processed facial image, srcU and srcV is the chroma of the to-be-processed facial image, srcR is red channel information of the to-be-processed facial image, srcG is green channel information of the to-be-processed facial image, and srcB is blue channel information of the to-be-processed facial image.

After converting the to-be-processed facial image from the YUV color space to the RGB color space, the to-be-processed facial image is converted from the RGB color space to the HSV color space using, for example, a following formula (3):

$$[ hTmp , sTmp , vTmp ] [ RGB 2 HSV ( srcR , srcG , srcB ) , \qquad ( 3 )$$

where RGB 2HSV ( ) represents the conversion from the RGB color space to the HSV color space, hTmp is the hue of the to-be-processed facial image, sTmp is the saturation of the to-be-processed facial image, vTmp is the value of the to-be-processed facial image, srcR is red channel information of the to-be-processed facial image, srcG is green channel information of the to-be-processed facial image, and srcB is blue channel information of the to-be-processed facial image.

In some embodiments, said acquiring the initial image of the lipstick trial makeup based on the value of the to-be-processed facial image, and the hue and saturation of the target lipstick sample in the HSV color space is acquiring the initial image of the lipstick trial makeup based on the value of the to-be-processed facial image in the HSV color space, and the hue and saturation of the target lipstick sample in the HSV color space.

For example, the initial image of lipstick trial makeup is acquired based on a following formula (4),

$$[ dstR , dstG , dstB ] = HSV 2 RGB ( h , s , vTmp ) , \qquad ( 4 )$$

where HSV 2 RGB ( ) represents the conversion from the HSV color space to the RGB color space, dstR is red channel information of the initial image of lipstick trial makeup, dstG is green channel information of the initial image of lipstick trial makeup, dstB is blue channel information of the initial image of lipstick trial makeup, h is the hue of the target lipstick sample, S is the saturation of the target lipstick sample, and vTmp is the value of the to-be-processed facial image.

In some embodiments, when the to-be-processed facial image adopts the YUV color space and the color of the target lipstick sample adopts the YUV color space, the initial image of lipstick trial makeup may be acquired based on the luminance Y of the to-be-processed facial image in the YUV color space, and the color (UV) of the color of the target lipstick sample in the YUV color space.

In some embodiments, when the to-be-processed facial image adopts the YUV color space and the color of the target lipstick sample adopts another type of color space such as the RGB color space or the HSV color space, the another type of color space such as the RGB color space or the HSV color space which is adopted by the color of the target lipstick sample is converted to the YUV color space. The initial image of lipstick trial makeup may be acquired based on the luminance Y of the to-be-processed facial image in the YUV color space, and the color (UV) of the color of the target lipstick sample in the YUV color space.

In some embodiments, when the to-be-processed facial image adopts the HSV color space, and the color of the target lipstick sample adopts the HSV color space, the initial image of lipstick trial makeup may be acquired based on the value V of the to-be-processed facial image in the HSV color space, and the hue H and saturation S of the color of the target lipstick sample in the HSV color space.

It could be understood that the to-be-processed facial image and the color of the target lipstick sample may correspond to other color spaces, which is not described in detail here. A following rule should be followed for processing. If the color space of the to-be-processed facial image and the color space of the color of the target lipstick sample are the same, and the initial color space type can perform luminance and color separation, the initial image of lipstick trial makeup is acquired based on the luminance of the to-be-processed facial image in the initial color space, and the color of the color of the target lipstick sample in the initial color space. If the color space of the to-be-processed facial image and the color space of the color of the target lipstick sample are not the same, one or both of the color space of the to-be-processed facial image and the color space of the color of the target lipstick sample is converted into a color space that can perform luminance and color separation, the initial image of lipstick trial makeup is acquired based on the converted color space, the luminance of the to-be-processed facial image in the converted color space, and the color of the color of the target lipstick sample in the converted color space.

In S13, image fusion is performed on the initial image of lipstick trial makeup and the to-be-processed facial image based on the lip mask to acquire a lipstick trial makeup image.

From above, the initial image of lipstick trial makeup is acquired based on the luminance of the to-be-processed facial image subjected to luminance and color separation, and the color of the target lipstick sample subjected to luminance and color separation. Image fusion is performed on the initial image of lipstick trial makeup and the to-be-processed facial image based on the lip mask to acquire the lipstick trial makeup image. As the initial image of lipstick trial makeup is acquired based on the luminance of the to-be-processed facial image subjected to luminance and color separation, the initial image of the lipstick trial makeup cannot only present a color of the lipstick, but also contain texture information of the lip area. Therefore, the lipstick trial makeup image acquired based on the fusion of the initial image of lipstick trial makeup and the to-be-processed facial image can better retain the texture information of the lip area, and takes into account real lip colors of different groups of people, so as to better simulate a real effect of lipstick color applied to lips, thereby reducing a difference between lipstick coloring effect in the lipstick trial makeup image and an actual lipstick coloring effect in reality, and improving the lipstick coloring effect and naturalness in the lipstick trial makeup image.

In some embodiments, S13 may include: acquiring a first fusion weight corresponding to the initial image of lipstick trial makeup and a second fusion weight corresponding to the to-be-processed facial image; and performing image fusion on the initial image of lipstick trial makeup and the to-be-processed facial image based on the first fusion weight and the second fusion weight to acquire the lipstick trial makeup image. The first fusion weight is associated with the lip mask, that is, acquired based on the lip mask.

Specifically, the first fusion weight is used to weight the initial image of lipstick trial makeup to acquire a first weighted result, and the second fusion weight is used to weight the to-be-processed facial image to acquire a second weighted result. The lipstick trial makeup image is acquired based on the first weighted result and the second weighted result.

In some embodiments, in a specified color space, image fusion is performed on the initial image of lipstick trial makeup and the to-be-processed facial image based on the lip mask to acquire the lipstick trial makeup image. The specified color space may be the RGB color space, the YUV color space, or other appropriate color spaces.

In some embodiments, when the color space type of the initial image of lipstick trial makeup is different from the color space type of the to-be-processed facial image, one of both of the color space type of the initial image of lipstick trial makeup and the color space type of the to-be-processed facial image is performed with color space conversion, so that the color space type of the initial image of lipstick trial makeup and the color space type of the to-be-processed facial image are the same.

In some embodiments, image fusion is performed on the initial image of lipstick trial makeup and the to-be-processed facial image based on the lip mask to acquire the lipstick trial makeup image in the RGB color space by using following formulas (5), (6) and (7):

$${dstR}^{′} = ( srcR ▯ β + dst R ▯ α ) / W \qquad ( 5 )$$

$${dstG}^{′} = ( srcG ▯ β + dst G ▯ α ) / W \qquad ( 6 )$$

$${dstB}^{′} = ( srcB ▯ β + dst B ▯ α ) / W , \qquad ( 7 )$$

where dstR′ is the red channel information of the lipstick trial makeup image, dstG′ is green channel information of the lipstick trial makeup image, dstB′ is blue channel information of the lipstick trial makeup image, α is the first fusion weight, β is the second fusion weight, and W is an upper limit of fusion weight.

When the lip mask uses a grayscale value (color depth) to represent the fusion weight of each pixel, and the grayscale value has 8 bits, a value range of the fusion weight of each pixel is [0, 255]. In this case, W=255. When the lip mask uses coefficients to represent the fusion weight, the value range of the fusion weight of each pixel is [0, 1]. In this case, W=1.

Further, an intensity coefficient of lipstick trial makeup effect is acquired, and the first fusion weight is determined based on the intensity coefficient of lipstick trial makeup effect and the lip mask. The intensity coefficient of lipstick trial makeup effect is used to adjust effect intensity of the lipstick and can be configured by users according to their needs to meet personalized needs of different users.

For example, a lipstick effect intensity adjustment intensity bar or a button may be configured on a user interface, and the intensity coefficient of lipstick trial makeup effect is adjusted by dragging the lipstick effect intensity adjustment intensity bar or operating the button. The greater the intensity coefficient of lipstick trial makeup effect, the more obvious the lipstick makeup effect; and the smaller the intensity coefficient of lipstick makeup effect, the less obvious the lipstick trial makeup effect. When the intensity coefficient of lipstick trial makeup effect is 0, there is no lipstick makeup effect.

For example, the first fusion weight may be acquired based on a following formula (8):

$$α = lipModel ▯ σ , \qquad ( 8 )$$

where α is the first fusion weight, lipModel is the lip mask, σ is the intensity coefficient of lipstick trial makeup effect, and σ∈[0,1].

Further, the second fusion weight may be calculated based on the first fusion weight and a maximum weight.

For example, the second fusion weight may be acquired based on a following formula (9):

$$β = W - α , \qquad ( 9 )$$

where β is the second fusion weight, and W is the maximum weight.

In some embodiments, the lip mask is the fusion weight of each pixel in the initial image of lipstick trial makeup. A fusion weight of pixels in a non-lip area in the initial image of lipstick trial makeup may be 0, so that the non-lip area in the initial image of lipstick trial makeup does not participate in the image fusion when the initial image of lipstick trial makeup is fused with the to-be-processed facial image, that is, information about the non-lip area in the lipstick trial makeup image acquired by the image fusion comes from the to-be-processed facial image. However, a fusion weight of pixels in the lip area in the initial image of lipstick trial makeup is not 0, so that the lip area of the lipstick trial makeup image acquired by the image fusion comes from the initial image of lipstick trial makeup and the to-be-processed facial image.

In practice, considering that even the same color may have different effects under different luminance, to further improve the lipstick makeup effect presented in the acquired lipstick trial makeup image, in the embodiments of the present disclosure, the luminance of the to-be-processed facial image subjected to luminance and color separation may be adjusted as follows. Initial luminance of the to-be-processed facial image is acquired, and the initial luminance is adjusted using a lipstick trial makeup target luminance coefficient to acquire the luminance of the to-be-processed facial image subjected to luminance and color separation.

Taking the HSV color space as an example, adjusting the luminance of the to-be-processed facial image subjected to luminance and color separation may include: acquiring initial value of the to-be-processed facial image in the HSV color space; and adjusting the initial value using the lipstick trial makeup target luminance coefficient to acquire value of the to-be-processed facial image in the HSV color space.

In some embodiments, the lipstick trial makeup target luminance coefficient is multiplied by the initial value to acquire a product which is the adjusted value, i.e., the value of the to-be-processed facial image in the HSV color space.

Further, the lipstick trial makeup target luminance coefficient is calculated based on preset luminance of the target lipstick sample and luminance of the lip area of the to-be-processed facial image. The lipstick trial makeup target luminance coefficient is used to adjust the luminance effect of the target lipstick sample.

In some embodiments, a ratio of the preset luminance of the target lipstick sample to the luminance of the lip area of the to-be-processed facial image is calculated; in response to the ratio being less than 1, it is determined that the lipstick trial makeup target luminance coefficient is the ratio; and in response to the ratio being greater than or equal to 1, it is determined that the lipstick trial makeup target luminance coefficient is 1.

For example, the lipstick trial makeup target luminance coefficient is determined based on a following formula (10):

$$k = MIN ( Y / {srcY}_{mean} , 1 ) , \qquad ( 10 )$$

where k is the lipstick trial makeup target luminance coefficient, k∈[0,1], MIN( ) is a minimum value, Y is the preset luminance of the target lipstick sample, and SrcYₘₑₐₙ is the luminance of the lip area of the to-be-processed facial image.

In some embodiments, the luminance of the lip area may be determined by performing face recognition on the to-be-processed facial image or detecting face key points. The luminance of the lip area is determined based on the luminance of each pixel in the lip area. For example, average luminance of all the pixels in the lip area serves as the luminance of the lip area.

In practice, as lipstick samples have different texture types, such as matte, velvet, satin, moisturizing, or glossy, different texture types present different degrees of gloss, thus, lipsticks with different texture types provide different gloss effect after application.

To further improve closeness between the trial makeup effect of lipsticks with different texture types and the real makeup effect in reality and reduce a difference therebetween, in some embodiments of the present disclosure, image fusion is performed on the initial image of lipstick trial makeup and the to-be-processed facial image based on the lip mask to acquire the intermediate image, the intensity coefficient of lipstick glossy texture effect corresponding to lipstick texture of the target lipstick sample is acquired, the luminance adjustment amount of the lip area is acquired based on the intensity coefficient of lipstick glossy texture effect, the lip mask, the luminance of the to-be-processed facial image and the luminance of the lip area, and the luminance of the intermediate image is adjusted based on the luminance adjustment amount to acquire the lipstick trial makeup image. The lipstick glossy texture effect intensity coefficient is used to adjust glossiness of the lipstick after makeup is applied. The greater the lipstick glossy texture effect intensity coefficient, the higher the glossiness of the lipstick after makeup is applied.

In some embodiments, the luminance adjustment amount of the lip area is calculated, and the luminance of the intermediate image is adjusted based on the luminance adjustment amount in the YUV color space by using a following formula (11):

$$▯Y = δ ▯ MAX ( srcY - {srcY}_{mean} , 0 ) ▯ lipModel / W \qquad ( 11 )$$

$${dstY}^{′} = dstY + ▯ Y , \qquad ( 12 )$$

where [symbol] Y is the luminance adjustment amount, δ is the lipstick glossy texture effect intensity coefficient, δ∈[0, m], m>0, srcY is the luminance of the to-be-processed facial image, srcYₘₑₐₙ is the luminance of the lip area, lipModel is the lip mask, W is the maximum weight, dstY′ is the luminance of the lipstick trial makeup image, i.e., the adjusted luminance of the intermediate image, and dstY is the luminance of the intermediate image.

It could be understood that when the color space types used are different, the above-mentioned method of calculating the luminance adjustment amount of the lip area and adjusting the luminance of the intermediate image based on the luminance adjustment amount may refer to the above formulas (11) and (12), which is not described in detail here.

In some embodiments, the lipstick glossy texture effect intensity coefficients corresponding to various texture types can be pre-configured. Corresponding identifiers can be assigned to different texture types, and each identifier is mapped to one corresponding lipstick glossy texture effect intensity coefficient. For example, lip Type=1 means that the lipstick texture is matte, while lip Type=2 means that the lipstick texture is glossy. For texture types that do not need to adjust the lipstick glossy texture effect, δ=0 may be configured. For texture types that need to adjust the lipstick glossy texture effect, values of δ and m may be configured based on experience.

In some embodiments, the value of m is 2. It could be understood that requirements for adjusting the lipstick glossy texture effect are different, and m can also have other values, which is not limited here.

In practice, to present a better lipstick makeup effect, some users will apply base makeup on their lips before applying lipstick, such as using liquid foundation or concealer to modify or cover an original lip color. To enable these people with personalized needs acquire the lipstick trial makeup image as close as possible to the actual lipstick makeup effect in reality to reduce a difference between a virtual trial makeup effect and the actual makeup effect, in some embodiments of the present disclosure, prior to said performing image fusion on the initial image of lipstick trial makeup and the to-be-processed facial image based on the lip mask to acquire a lipstick trial makeup image, the method further includes: acquiring color information of a lip concealer sample, and acquiring a base makeup image based on the luminance of the to-be-processed facial image subjected to luminance and color separation, and a color of the lip concealer sample subjected to luminance and color separation; and performing image fusion on the base makeup image and the to-be-processed facial image based on the lip mask to acquire the adjusted to-be-processed facial image.

When performing image fusion on the base makeup image and the to-be-processed facial image based on the lip mask, a third fusion weight may be calculated based on the lip mask, and a fourth fusion weight may be calculated based on the third fusion weight and a maximum weight. The third fusion weight is weighted with the base makeup image to acquire a third weighted result. The fourth fusion weight is weighted with the to-be-processed facial image to acquire a fourth weighted result. Based on the third weighted result and the fourth weighted result, the to-be-processed facial image after the fusion with the base makeup serves as the to-be-processed facial image, and subsequent fusion with the initial image of lipstick trial makeup is performed based on the to-be-processed facial image acquired after the fusion with the base makeup image. The maximum weight refers to an upper limit of fusion weight.

Further, a concealment intensity coefficient may be acquired, and the third fusion weight may be determined based on the concealment intensity coefficient and the lip mask. The fourth fusion weight is calculated based on the third fusion weight and the maximum weight. The concealment intensity coefficient is used to represent concealment intensity of the original lip color in the to-be-processed facial image by the lip concealment sample. The larger the concealment intensity coefficient, the better the concealment effect of the original lip color in the to-be-processed facial image.

When the lip mask uses a grayscale value (color depth) to represent the fusion weight of each pixel, a value range of the fusion weight of each pixel is [0, 255]. In this case, W=255. When the lip mask uses coefficients to represent the fusion weight, the value range of the fusion weight of each pixel is [0, 1]. In this case, W=1.

To facilitate those skilled in the art better understanding and implementing the embodiments of the present disclosure, referring to FIG. 3, another facial image processing method is provided according to an embodiment, which may include following steps.

In S301, face recognition is performed on a to-be-processed facial image.

In S302, it is determined whether a distance between a biggest face and a camera meets a requirement.

S302 is used to detect the to-be-processed facial image, so as to process the to-be-processed facial image. Specific implementation methods thereof may be referred to the descriptions of relevant parts in the above embodiments, which is not repeated here.

If the determination result is yes, S304 is performed; and if the determination result is no, S303 is performed.

In S303, no virtual lipstick makeup is performed.

Following S303, the process may be terminated, or a next to-be-processed facial image may be acquired, and S301 is continued.

In S304, detection of face key points is performed on the to-be-processed facial image.

In S305, it is determined whether a lip of a human face is blocked.

If the determination result is yes, S303 is performed; and if the determination result is no, S306 is performed.

In S306, luminance of the lip and a lip mask are acquired.

In S307, fusion and rendering of a lipstick color are performed.

The fusion and rendering of the lipstick color may be implemented through S11 and S12 in the above embodiments, which is not repeated here.

Prior to S307, S310 may be performed to select a lipstick model. By selecting the lipstick model, a target lipstick sample is determined, and color information of the target lipstick sample may also be determined.

In S308, a lipstick texture effect is controlled.

Controlling of the lipstick texture effect may include: performing image fusion on the initial image of lipstick trial makeup and the to-be-processed facial image based on the lip mask to acquire an intermediate image; acquiring an intensity coefficient of lipstick glossy texture effect corresponding to lipstick texture of the target lipstick sample; calculating a luminance adjustment amount of the lip area based on the intensity coefficient of lipstick glossy texture effect, the lip mask, luminance of the to-be-processed facial image and luminance of the lip area; and adjusting luminance of the intermediate image based on the luminance adjustment amount to acquire the lipstick trial makeup image. More details may be referred to the relevant descriptions in the above embodiments and are not repeated here.

Prior to S308, S311 may be performed to select a lipstick texture.

In S309, a virtual lipstick trial makeup image is output.

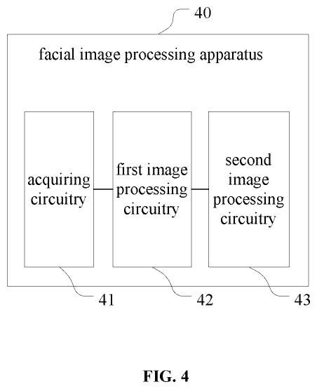

FIG. 4 is a block diagram of a facial image processing apparatus according to an embodiment. The facial image processing apparatus 40 includes an acquiring circuitry 41, a first image processing circuitry 42 and a second image processing circuitry 43.

The acquiring circuitry 41 is configured to acquire a lip mask in a to-be-processed facial image, wherein the lip mask is a mask of a lip area.

The first image processing circuitry 42 is configured to acquire an initial image of lipstick trial makeup based on luminance of the to-be-processed facial image subjected to luminance and color separation, and a color of a target lipstick sample subjected to luminance and color separation.

The second image processing circuitry 43 is configured to perform image fusion on the initial image of lipstick trial makeup and the to-be-processed facial image based on the lip mask to acquire a lipstick trial makeup image.

In some embodiments, more details of working principles and procedures of the facial image processing apparatus 40 may be referred to the above description of the facial image processing method provided in any one of the above embodiments and are not repeated here.

In some embodiments, the facial image processing apparatus 40 may correspond to a chip with a facial image processing function in a terminal, or to a chip with a data processing function, or to a chip module containing a chip with a facial image processing function in a terminal, or to a chip module containing a chip with a data processing function, or to a terminal.

In some embodiments, modules/units included in each apparatus and product described in the above embodiments may be software modules/units, hardware modules/units, or a combination of software modules/units and hardware modules/units.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a non-volatile or non-transitory computer-readable storage medium having computer instructions stored therein is provided, wherein when the computer instructions are executed by a processor, the facial image processing method provided in any one of the above embodiments is performed.

In an embodiment of the present disclosure, a terminal including a memory and a processor is provided, wherein the memory has computer instructions stored therein, and when the processor executes the computer instructions, the facial image processing method provided in any one of the above embodiments is performed.

Those skilled in the art could understand that all or part of steps in the various methods in the above embodiments can be completed by instructing relevant hardware through a program, and the program can be stored in any computer-readable storage medium which includes a ROM, a RAM, a magnetic disk or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A facial image processing method, comprising:
acquiring a lip mask in a to-be-processed facial image, wherein the lip mask is a mask of a lip area;
acquiring an initial image of lipstick trial makeup based on luminance of the to-be-processed facial image subjected to luminance and color separation, and a color of a target lipstick sample subjected to luminance and color separation; and
performing image fusion on the initial image of lipstick trial makeup and the to-be-processed facial image based on the lip mask to acquire a lipstick trial makeup image.

2. The method according to claim 1, wherein said performing image fusion on the initial image of lipstick trial makeup and the to-be-processed facial image based on the lip mask to acquire the lipstick trial makeup image comprises:
acquiring a first fusion weight corresponding to the initial image of lipstick trial makeup and a second fusion weight corresponding to the to-be-processed facial image, wherein the first fusion weight is associated with the lip mask; and
performing image fusion on the initial image of lipstick trial makeup and the to-be-processed facial image based on the first fusion weight and the second fusion weight to acquire the lipstick trial makeup image.

3. The method according to claim 2, wherein said acquiring the first fusion weight and the second fusion weight comprises:
acquiring an intensity coefficient of lipstick trial makeup effect;
determining the first fusion weight based on the intensity coefficient of lipstick trial makeup effect and the lip mask; and
calculating the second fusion weight based on the first fusion weight and a maximum weight, wherein the maximum weight is an upper limit of a value of fusion weight.

4. The method according to claim 1, further comprising: adjusting luminance of the to-be-processed facial image subjected to luminance and color separation, wherein said adjusting the luminance of the to-be-processed facial image subjected to luminance and color separation comprises:
acquiring initial luminance of the to-be-processed facial image; and
adjusting the initial luminance using a lipstick trial makeup target luminance coefficient to acquire the luminance of the to-be-processed facial image subjected to luminance and color separation.

5. The method according to claim 4, wherein the lipstick trial makeup target luminance coefficient is calculated based on preset luminance of the target lipstick sample and luminance of the lip area of the to-be-processed facial image.

6. The method according to claim 5, wherein said calculating the lipstick trial makeup target luminance coefficient based on the preset luminance of the target lipstick sample and the luminance of the lip area of the to-be-processed facial image comprises:
calculating a ratio of the preset luminance of the target lipstick sample to the luminance of the lip area of the to-be-processed facial image;
in response to the ratio being less than 1, determining that the lipstick trial makeup target luminance coefficient is the ratio; and
in response to the ratio being greater than or equal to 1, determining that the lipstick trial makeup target luminance coefficient is 1.

7. The method according to claim 1, further comprising:
performing image fusion on the initial image of lipstick trial makeup and the to-be-processed facial image based on the lip mask to acquire an intermediate image;
acquiring an intensity coefficient of lipstick glossy texture effect corresponding to lipstick texture of the target lipstick sample;
calculating a luminance adjustment amount of the lip area based on the intensity coefficient of lipstick glossy texture effect, the lip mask, luminance of the to-be-processed facial image and luminance of the lip area; and
adjusting luminance of the intermediate image based on the luminance adjustment amount to acquire the lipstick trial makeup image.

8. The method according to claim 7, wherein said calculating the luminance adjustment amount of the lip area based on the intensity coefficient of lipstick glossy texture effect, the lip mask, luminance of the to-be-processed facial image and luminance of the lip area comprises:
determining a maximum value among the luminance of the to-be-processed facial image and the luminance of the lip area; and
calculating the luminance adjustment amount of the lip area based on the maximum value, the intensity coefficient of lipstick glossy texture effect and the lip mask.

9. The method according to claim 1, wherein said acquiring the lip mask in the to-be-processed facial image comprises:
performing face key point alignment on the to-be-processed facial image, and determining the lip area based on lip key points among the face key points;
retaining the lip area, triangulating areas in the to-be-processed facial image except the lip area, and acquiring a binary image by converting;
performing edge smoothing on the binary image by using luminance channel information of the to-be-processed facial image as a guide map; and
determining the lip mask based on the binary image subjected to the edge smoothing.

10. The method according to claim 1, wherein prior to said performing image fusion on the initial image of lipstick trial makeup and the to-be-processed facial image based on the lip mask to acquire a lipstick trial makeup image, the method further comprises:
acquiring color information of a lip concealer sample, and acquiring a base makeup image based on the luminance of the to-be-processed facial image subjected to luminance and color separation, and a color of the lip concealer sample subjected to luminance and color separation; and
performing image fusion on the base makeup image and the to-be-processed facial image based on the lip mask to acquire the adjusted to-be-processed facial image.

11. The method according to claim 1, wherein prior to said acquiring the initial image of lipstick trial makeup based on the luminance of the to-be-processed facial image subjected to luminance and color separation, and the color of the target lipstick sample subjected to luminance and color separation, the method further comprises:
in response to a color space type of the to-be-processed facial image being different from a color space type of the target lipstick sample, converting the color space type of the to-be-processed facial image and the color space type of the target lipstick sample to a same color space type.

12. (canceled)

13. A non-volatile or non-transitory computer readable storage medium storing one or more programs, the one or more programs comprising computer instructions, which, when executed by a processor, cause the processor to:
acquire a lip mask in a to-be-processed facial image, wherein the lip mask is a mask of a lip area;
acquire an initial image of lipstick trial makeup based on luminance of the to-be-processed facial image subjected to luminance and color separation, and a color of a target lipstick sample subjected to luminance and color separation; and
perform image fusion on the initial image of lipstick trial makeup and the to-be-processed facial image based on the lip mask to acquire a lipstick trial makeup image.

14. A terminal comprising a memory and a processor, wherein the memory stores one or more programs, the one or more programs comprising computer instructions, which, when executed by the processor, cause the processor to:
acquire a lip mask in a to-be-processed facial image, wherein the lip mask is a mask of a lip area;
acquire an initial image of lipstick trial makeup based on luminance of the to-be-processed facial image subjected to luminance and color separation, and a color of a target lipstick sample subjected to luminance and color separation; and
perform image fusion on the initial image of lipstick trial makeup and the to-be-processed facial image based on the lip mask to acquire a lipstick trial makeup image.

15. The terminal according to claim 14, wherein the processor is further caused to:
acquire a first fusion weight corresponding to the initial image of lipstick trial makeup and a second fusion weight corresponding to the to-be-processed facial image, wherein the first fusion weight is associated with the lip mask; and
perform image fusion on the initial image of lipstick trial makeup and the to-be-processed facial image based on the first fusion weight and the second fusion weight to acquire the lipstick trial makeup image.

16. The terminal according to claim 15, wherein the processor is further caused to:
acquire an intensity coefficient of lipstick trial makeup effect;
determine the first fusion weight based on the intensity coefficient of lipstick trial makeup effect and the lip mask; and
calculate the second fusion weight based on the first fusion weight and a maximum weight, wherein the maximum weight is an upper limit of a value of fusion weight.

17. The terminal according to claim 14, wherein the processor is further caused to adjust luminance of the to-be-processed facial image subjected to luminance and color separation, wherein the processor is further caused to:
acquire initial luminance of the to-be-processed facial image; and
adjust the initial luminance using a lipstick trial makeup target luminance coefficient to acquire the luminance of the to-be-processed facial image subjected to luminance and color separation.

18. The terminal according to claim 14, wherein the processor is further caused to:
perform image fusion on the initial image of lipstick trial makeup and the to-be-processed facial image based on the lip mask to acquire an intermediate image;
acquire an intensity coefficient of lipstick glossy texture effect corresponding to lipstick texture of the target lipstick sample;
calculate a luminance adjustment amount of the lip area based on the intensity coefficient of lipstick glossy texture effect, the lip mask, luminance of the to-be-processed facial image and luminance of the lip area; and
adjust luminance of the intermediate image based on the luminance adjustment amount to acquire the lipstick trial makeup image.

19. The terminal according to claim 14, wherein the processor is further caused to:
perform face key point alignment on the to-be-processed facial image, and determine the lip area based on lip key points among the face key points;
retain the lip area, triangulate areas in the to-be-processed facial image except the lip area, and acquire a binary image by converting;
perform edge smoothing on the binary image by using luminance channel information of the to-be-processed facial image as a guide map; and
determine the lip mask based on the binary image subjected to the edge smoothing.

20. The terminal according to claim 14, wherein the processor is further caused to:
acquire color information of a lip concealer sample, and acquire a base makeup image based on the luminance of the to-be-processed facial image subjected to luminance and color separation, and a color of the lip concealer sample subjected to luminance and color separation; and
perform image fusion on the base makeup image and the to-be-processed facial image based on the lip mask to acquire the adjusted to-be-processed facial image.

21. The terminal according to claim 14, wherein the processor is further caused to:
in response to a color space type of the to-be-processed facial image being different from a color space type of the target lipstick sample, convert the color space type of the to-be-processed facial image and the color space type of the target lipstick sample to a same color space type.
